(19) United States
(12) Patent Application Publication
(10) Pub. No.: US 2024/0409079 A1
(43) Pub. Date: Dec. 12, 2024

(54) ANTI-ROLL BAR TORQUE ESTIMATION

(71) Applicant: JAGUAR LAND ROVER LIMITED, Warwickshire (GB)

(72) Inventors: Adrian Bouaru, Whitley, Coventry, Warwickshire (GB); Ihab Samy, Whitley, Coventry, Warwickshire (GB)

(21) Appl. No.: 18/702,441

(22) PCT Filed: Oct. 18, 2021
(86) PCT No.: PCT/EP2021/078798

§ 371 Date: Apr. 18, 2024

(51) Int. Cl. B60W 10/04; B60W 50/04

(52) U.S. Cl. CPC B60W 10/04; B60W 50/04; B60W 2400/00; B60W 2510/09; B60W 2510/22; B60W 2555/00; B60W 2710/09

(57) ABSTRACT

Aspects relate to a control system and method for a vehicle suspension system in a vehicle. The control system (100, 200) is configured to: receive a disturbance angle (316) of a roll bar of the vehicle suspension system, the disturbance angle indicative of a determined relative angular displacement between ends of the roll bar caused by the vehicle interacting with a driving surface; receive a displacement value (322) of an actuator motor of the actuator of the vehicle suspension system, the displacement value of the actuator motor indicative of a sensed displacement of the actuator motor caused by the vehicle interacting with the driving surface; determine, in dependence on the disturbance angle of the roll bar and the displacement value of the actuator motor, a torque estimation (332), the torque estimation representing an expected torque provided by the actuator motor to a roll bar connected to the actuator motor; and output the torque estimation to a further vehicle system.

### TECHNICAL FIELD

The present disclosure relates to anti-roll bar torque estimation. Aspects of the invention relate to a control system, a system, a vehicle, a method, and computer readable instructions, for estimating anti-roll bar torque.

### BACKGROUND

Vehicles (for example petrol, diesel, electric or hybrid vehicles) comprise active suspension systems, such as an electronic active roll control system, for maintaining vehicle stability and user comfort. Such electronic active roll control systems comprise at least one actuator, the actuator being configured so as to actively impart motor control on the suspension system, the at least one actuator being coupled to a roll bar.

Such active suspension systems may include a number of individual subcomponents or mechatronic subsystems. There may be a high level vehicle control generating a system demand signal, for example a torque demand signal, to influence vehicle motion. There may be a low level controller providing control signals to an actuator (for example to provide motor control) of the active suspension system, to deliver the demanded signal provided. There may be associated mechanical or electromechanical components to deliver a physical manifestation of the demanded signal, for example a motor. There may be a dedicated power supply system. There may be significant interaction between these subsystems in order to provide operation of the active suspension system.

Such suspension systems may have a high functional integrity requirement at the vehicle level. However, the individual subcomponents comprising the system may each have lower standalone capabilities in terms of the functional integrity (for example Automotive Safety Integrity Level, ASIL) level they can achieve. For example, they may operate at a lower functional integrity requirement at the component level based on direct measurement of torque in the system using a sensing element. There is therefore a categorisation gap between the functional operating level of the individual elements and the desired vehicle level operation.

It is an aim of the present invention to address one or more of the disadvantages associated with the prior art. Examples disclosed herein provide an independent method of torque estimation at the vehicle level than the methods performed by individual subcomponents to achieve the desired vehicle level target.

### SUMMARY OF THE INVENTION

Aspects and embodiments of the invention provide a control system, a system, a vehicle, a method, and computer readable instructions, for estimating anti-roll bar torque, as claimed in the appended claims

According to an aspect of this disclosure there is provided a control system for a vehicle suspension system in a vehicle, the control system comprising one or more controllers, the control system configured to:
receive a disturbance angle of a roll bar of the vehicle suspension system, the disturbance angle indicative of a determined relative angular displacement between ends of the roll bar caused by the vehicle interacting with a driving surface;
receive a displacement value of an actuator motor of the actuator of the vehicle suspension system, the displacement value of the actuator motor indicative of a sensed displacement of the actuator motor caused by the vehicle interacting with the driving surface;
determine, in dependence on the disturbance angle of the roll bar and the displacement value of the actuator motor, a torque estimation, the torque estimation representing an expected torque provided by the actuator motor to a roll bar connected to the actuator motor; and
output the torque estimation to a further vehicle system.

The control system may be configured to: determine a function of a difference between the torque estimation and a current torque demand being requested by the vehicle suspension system, the torque demand being requested by the vehicle suspension system in response to the vehicle interacting with the driving surface; and if the determined function of the difference is above a predetermined threshold, output a fault signal. The control system may be configured to provide the fault signal to a fault bus of the vehicle suspension system.

The control system may be configured to: calculate the torque estimation using a first calculation component and a second calculation component, wherein the first calculation component is based on a predetermined model of the vehicle suspension system and the second calculation component is based on at least one vehicle characteristic. For example, the first calculation component may be based on an analytical model of the vehicle suspension system, and the second calculation component may be based on an empirical model of a plurality of vehicle characteristics.

Determining the first calculation component may comprise: receiving at least one sensor signal indicative of the vehicle interacting with a driving surface; inputting the at least one sensor signal into the theoretical model, wherein the theoretical model comprises a kinematic model configured to estimate behaviour of the vehicle suspension system in dependence on a geometry of the vehicle suspension system and a torque demand applied to the vehicle suspension system; and determining the disturbance angle in dependence on the at least one sensor signal and an estimated behaviour determined from the theoretical model.

The at least one sensor signal may indicate: one or more of a height of a left side and a height of a right side of the vehicle suspension determined by a respective suspension height sensor; a position of the actuator motor determined by an actuator motor position sensor; an acceleration of one or more hub of a wheel of the vehicle determined by a respective hub acceleration sensor; and the current torque demand requested by the vehicle suspension system determined by a vehicle level controller. The current torque demand represents the target torque that the system must achieve to deliver vehicle level attributes.

When the disturbance angle is determined in dependence on the at least one sensor signal and an estimated behaviour determined from the theoretical model, and the actuator motor position is determined by the actuator motor position sensor, the first calculation component may comprise one or more of correcting an offset of the determined disturbance angle and correcting an offset of the sensed position of the actuator motor. The first calculation component may comprise a function dependent on one or more of the offset corrected disturbance angle, the offset corrected actuator motor position, and a roll bar stiffness characteristic. The roll bar stiffness characteristic may be a torsional stiffness.

The second calculation component may comprise: receiving a result from the first calculation component; and compensating for the at least one vehicle characteristic in dependence on the result from the first calculation component and a system identification model, wherein the at least one vehicle characteristic is indicative of a change in geometry of the vehicle suspension system in response to a torque demand.

The system identification model may be determined in dependence on measured data relating to at least one of: a compliance parameter of one or more components of the vehicle; a user induced movement; data from the one or more sensors; and an associated measured torque. The measured data may be obtained from a plurality of different vehicle drive cycles.

The control system may be configured to: determine if the at least one sensor signal used in the first calculation component produces an artificial torque offset in the vehicle suspension system; and in dependence on determining that the at least one signal produces the artificial torque offset, rejecting the artificial torque offset.

According to a further aspect of this disclosure, there is provided a system, comprising: any control system disclosed here; at least one sensor configured to measure data relating to a vehicle travelling on a driving surface; and an actuator of a vehicle suspension system in a vehicle, the actuator comprising at least one actuator motor functionally connected to at least one roll bar, the actuator motor configured to apply a torsional force on the at least one roll bar.

According to a further aspect of this disclosure, there is provided a vehicle comprising any control system disclosed herein or any system disclosed herein.

According to a further aspect of this disclosure, there is provided a method, comprising: receiving a disturbance angle of a roll bar of a vehicle suspension system in a vehicle, the disturbance angle indicative of a determined relative angular displacement between ends of the roll bar caused by the vehicle interacting with a driving surface; receiving a displacement value of an actuator motor of the actuator of the vehicle suspension system, the displacement value of the actuator motor indicative of a sensed displacement of the actuator motor caused by the vehicle interacting with the driving surface; calculating, using the disturbance angle of the roll bar and the displacement value of the actuator motor, a torque estimation, the torque estimation representing an expected torque provided by the actuator motor to a roll bar connected to the actuator motor; and outputting the torque estimation.

The method may comprise determining a function of a difference between the torque estimation and a current torque demand being requested by the vehicle suspension system, the torque demand being requested by the vehicle suspension system in response to the vehicle interacting with the driving surface; and if the determined difference is above a predetermined threshold, outputting a fault signal to a fault bus of the vehicle suspension system.

The method may comprise calculating the torque estimation using a first calculation component and a second calculation component, wherein the first calculation component is based on a theoretical model of the vehicle suspension system and the second calculation component is based on at least one vehicle characteristic (for example an empirical model of the vehicle characteristic).

According to a further aspect of this disclosure, there is provided computer readable instructions which, when executed by a processor of any control system disclosed herein, are arranged to perform any method disclosed herein.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 shows an example control system for a vehicle according to examples disclosed herein;

FIG. 2a shows an example control system for a vehicle connected to front and rear anti-roll bars according to examples disclosed herein;

FIG. 2b shows an example control system for a vehicle comprising plural sub-systems, and front and rear anti-roll bars, according to examples disclosed herein;

FIG. 3a shows an example module for a control system of a vehicle according to examples disclosed herein;

FIGS. 3b-3e show example submodules of the control system of FIG. 3a according to examples disclosed herein;

FIG. 4 illustrates an actuator geometry indicating displacement angle according to examples disclosed herein;

FIGS. 5a-c show data indicating measured and estimated torque for a vehicle performing under different driving conditions, according to examples disclosed herein;

FIG. 6 shows an example method according to examples disclosed herein; and

FIG. 7 shows a vehicle in accordance with examples disclosed herein.

### DETAILED DESCRIPTION

Active suspension systems, such as electronic active roll control utilizing mechatronic systems, may include a cascade of systems, such as:
(a) a high level vehicle control layer, which may generate system demand signals (for example torque demands) to influence vehicle motion;
(b) a low level control layer, which may provide control signals to actuators (for example motor control) to deliver the demanded signal from the high level control; and
(c) a physical actuation layer, comprising motors and associated mechanical components to deliver the physical manifestation of the demanded signal.

The component from layer (b) may collect data from the physical actuation layer (c), such as motor temperature and/or motor position displacement. These measurements can be taken during normal module operation, and made available to the high layer vehicle control, for example via an automotive communication bus. Such suspension systems may have a high functional integrity requirement at the vehicle level. However, the individual subcomponents comprising the system (layers (a), (b), (c)) may each have lower standalone capabilities in terms of the functional integrity level they can achieve. For example, elements b and c may achieve a lower functional integrity level for torque error detection, for example based on direct measurement of torque in the system using a sensing element, or based on power consumption and/or other physical properties of the motor and associated mechanical components. There is therefore a categorisation gap between the individual elements operating at their individual levels, and the desired overall operation level at the vehicle level. The high level vehicle controller (a) would beneficially be able to implement an independent method to methods performed by layers (b) and (c) to allow the desired vehicle level target to be achieved. In the context of an electronic anti-roll control system, this may be achieved by determining the roll bar torque at a high level vehicle controller level (a) through one means, which is different to other means deployed through layers (b) and (c).

Examples disclosed herein provide for an independent method of determining the roll bar torque at the vehicle level (a) by obtaining a roll bar torque estimate. By obtaining the roll bar torque at the vehicle level (a) through a method independent from the methods used at the lower levels (b) and (c), the “gap may be closed” from individual component operating level at layers (b) and (c), and the overall vehicle operating level (c).

Methods and control systems disclosed herein provide for roll bar torque estimation based on determined mechanical movement. Vehicle level sensor signals, and suspension displacement and acceleration signals, may be mapped to the roll bar movements, for example via a kinematics model and using a Kalman filter. The resulting roll bar derived signals may be referred to as disturbance angle. An example roll bar torque estimation calibration process may comprise using models to obtain the disturbance angles. Motor displacement signals, measured via dedicated sensors, may also be obtained. The torque estimation process may comprise identification of an appropriate model, such as a linear time-invariant (LTI) model, which describes a transfer function between disturbance angle and/or the motor displacement signals, and a measured roll bar torque. Filters may be employed, for example filters calibrated using steady state rejection filters, for input signals representing the disturbance angle and/or motor positions to reduce steady state offsets from the signals (for example in a scenario such as vehicle kerb starts in which there is an initial steady offset due to being parked on an angle on the kerb). Such filters may be used to remove the steady state offsets, since input offsets may translate into artificial output torque offsets which are not representative of the system outside the “offset” conditions. Further filtering may be used in some examples to reduce high frequency noise in estimated torque signals through filtering the estimated raw output of the disturbance angle and/or motor positions signals. By making use of both physics based (analytical modelling and signal processing) and empirical modelling, advantages effects of both approaches may provide an improved torque estimation.

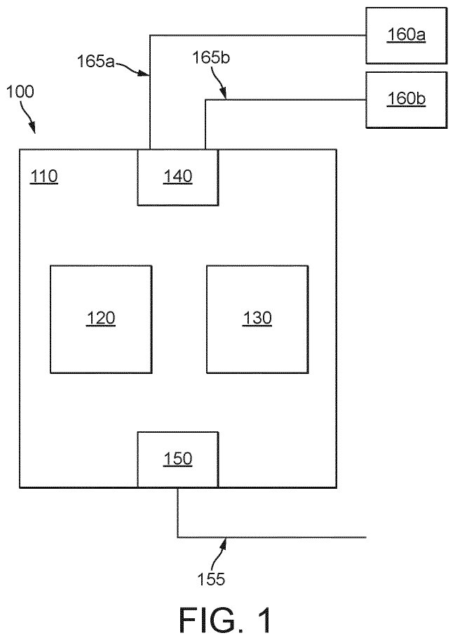

With reference to FIG. 1, there is illustrated a control system 100 for a vehicle. The control system 100 as illustrated in FIG. 1 comprises one controller 110, although it will be appreciated that this is merely illustrative and in other examples the control system 100 may comprise more than one controller 110. The controller 110 comprises processing means 120 and memory means 130. The processing means 120 may be one or more electronic processing device 120 which operably executes computer-readable instructions. The memory means 130 may be one or more memory device 130. The memory means 130 is electrically coupled to the processing means 120. The memory means 130 is configured to store instructions, and the processing means 120 is configured to access the memory means 130 and execute the instructions stored thereon.

The controller 110 comprises an input means 140 and an output means 150. The input means 140 may comprise an electrical input 140 of the controller 110. The output means 150 may comprise an electrical output 150 of the controller 100. The input 140 is arranged to receive a signals indicating one or more values which may be used to determine a disturbance angle 165a, from one or more sensors 160a providing those values (for example one or more height sensors and/or hub sensors). The disturbance angle may be a derived quantity obtained from one or more other measurements, rather than being a directly measured quantity itself. The input 140 is also arranged to receive a displacement value signal 165b from a displacement value sensor 160b. By “receive a disturbance angle” this is intended to mean that a signal indicating the disturbance angle of the roll bar (for example of the roll bar spade ends) is received by the controller 110 from a separate and communicatively coupled controller, or that the controller 110 itself determines the disturbance angle from one or more other received values.

The disturbance angle signal 165a is an electrical signal which is indicative of a determined relative angular displacement between ends of the roll bar (i.e. a rotational displacement of one roll bar end with respect to the opposite roll bar end; the end may be defined as the end where the roll bar spade end is located), for example at the roll bar spade ends, caused by the vehicle interacting with a driving surface. The displacement value signal 165b is an electrical signals which is indicative of a sensed displacement of the actuator motor caused by the vehicle interacting with the driving surface. The control system 100 is configured to determine a torque estimation in dependence on the disturbance angle of the roll bar and the displacement value of the actuator motor. The torque estimation represents an expected torque to be provided by the actuator motor to a roll bar connected to the actuator motor. The output 150 is arranged to output the torque estimation signal 155 to a further vehicle system. By providing an estimate of the torque which is actually being provided in the suspension system, the controller is able to compare the estimated and actual torque demands for the vehicle, and if the estimated torque being achieved in the suspension system is different from the actual torque demands by more than a predetermined tolerance, or threshold difference, this may be interpreted as a possible fault and an alert may be provided. In some examples the diagnostic fault check may be performed in the controller 100. In some examples the results of the torque estimate may be provided as an output signal 155 for use in a separate diagnostic system.

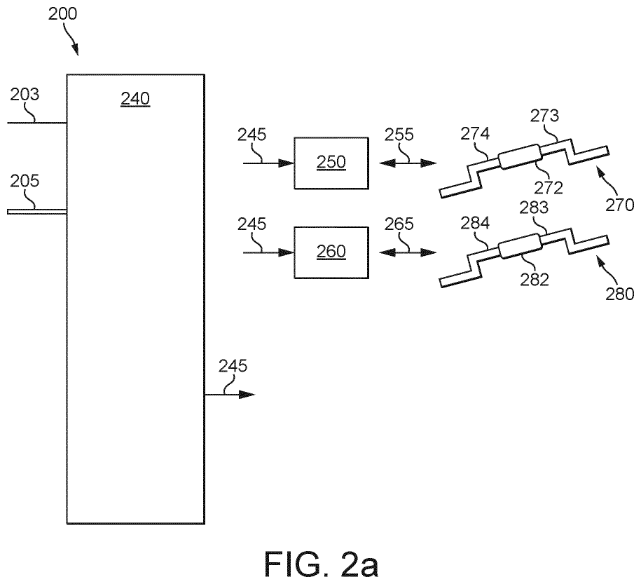

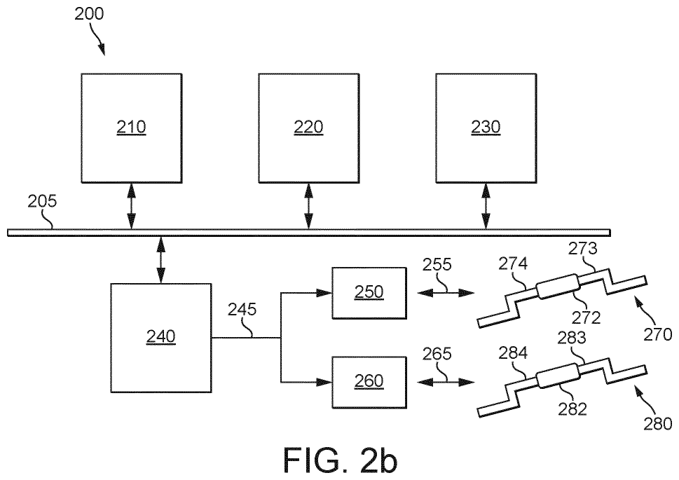

FIGS. 2a and 2b illustrate example control system 200 for a suspension system of a vehicle. A suspension system of a vehicle may comprise anti-roll bars 270, 280 which are controlled using an anti-roll control system. The terms “anti-roll bar” and “roll bar” are equivalent and used interchangeably throughout this disclosure. The anti-roll control system acts to control the anti-roll bars, to control a roll of a body of the vehicle and reduce the impact of disturbances from a road surface. The anti-roll control system may be electromechanical and/or hydraulic. Anti-roll bars 270, 280 may typically comprise stabiliser bars, typically metal, which join the vehicle suspension on either side of the vehicle axle, usually through drop links, and connect to a rotational actuator situated between the mounting points to the vehicle chassis. Each side of the anti-roll bar is able to rotate freely when a motor of the anti-roll control system is not energised. When the motor control is enabled (i.e. delivering torque), the anti-roll bar may act as a torsional spring. The anti-roll bars may be controlled to compensate for some vehicle movements such as body roll, for example from driving around a corner. Body roll can cause the wheels at the side of the vehicle outside the turn to reduce their contact with the road surface. Anti-roll bars may be controlled to counteract this effect and reduce the body roll effect, by transferring at least part of the additional load on the wheels at the side of the vehicle inside the turn to those wheels at the outside, for example by providing a torsional effect to pull the wheels towards the chassis and even out the imbalance in load on the wheels caused by cornering.

A typical suspension system may comprise passive front and rear anti-roll bars provided respectively between the front and rear pairs of wheels of a standard four-wheel vehicle. In a vehicle with an active roll control system, an anti-roll bar 270, 280 may respectively comprise two anti-roll bar ends 273, 274; 283, 284 connected together by a central having an actuator 272, 282. The central housing may additionally have one or more of a gearbox, sensors, and dedicated actuator controllers. The actuator 272, 282 acts to provide an actively controlled torque rather than a fixed torsional stiffness provided by passive anti-roll bars. One or more sensors may monitor the movement of the vehicle, and provide the sensed parameters as input to the active roll control system to control the actuator and provide a suitable torque to the anti-roll bar. The two ends of the anti-roll bar (273, 274; 283, 284) may be identical, or may be non-identical.

FIG. 2a shows an example control system 200 for a suspension system a vehicle, communicatively connected to front and rear anti-roll bars 270, 280. The control system 200 comprises a controller 240 which is connected by a communication channel 245 to anti-roll bar controllers 250, 260 configured to respectively control front and rear anti-roll actuators 272, 282. The controller 240 may be the controller 110 of FIG. 1. The controller 240 may comprise one or more of the controllers 110 of FIG. 1. In an example, the controller 240 may be a master controller for an electronic active roll control system in the vehicle. The controller 240 may host a vehicle level control strategy and actuation control for the electronic active roll control system in the vehicle.

The controller 240 may be configured to receive one or more sensor signal 203 from one or more sensors attached to the vehicle. The one or more sensor signals 203 may comprise, for example, a signal from a respective suspension height sensor of the vehicle suspension; a signal from a respective motor position sensor for the anti-roll bar actuators 272, 282; a signal from a respective hub acceleration sensor of the vehicle; and a signal from a respective torque demand sensor for the anti-roll bar actuators 272, 282. A suspension height sensor may be configured to determine a sensor signal indicative of one or more of a height of a left side and a height of a right side of the vehicle suspension. In some examples, the minimum amount of suspension sensing data needs to be per axle, i.e. both the front left and the front right data for the front axle is used. This may be obtained using one or more sensing element, such as a displacement sensor and an acceleration sensor fitted for each corner of the vehicle. Other sensing system configurations may be used in other examples.

A motor position sensor may be configured to determine a sensor signal indicative of a position of a respective motor of the anti-roll bar actuators 272, 282 (equivalent to a measure of the torsion angle of the roll bar) in conjunction with the disturbance angle obtained from analytical modelling. A hub acceleration sensor may be configured to determine a sensor signal indicative of an acceleration of one or more hub of a wheel of the vehicle. A torque demand sensor may be configured to provide a measure of an existing torque generated in the system, as a result of a target torque demand being requested by the controller—in some examples, the torque demand “sensor” is an element which obtains the vehicle level demanded torque.

The controller 240 may be configured to receive one or more communication signals via a communications bus 205. The communications bus 205 may be configured to deliver data to the controller 240 from other subsystems within the vehicle. For example, the communications bus 205 may be configured to communicate a signal indicating a status of one or more modules 210, 220, 230 that are in communicative connection with the controller 240 to the controller 240. In another example, the communications bus 205 may be configured to communicate a command from the controller 240 to the one or more modules 210, 220, 230 that are in communicative connection with the controller 240. The one or more modules 210, 220, 230, are discussed further in relation to FIG. 2b below. Signals transmitted over connections 203 or 245 may alternatively or additionally be transmitted over a communications bus 205.

The controller 240 may be configured to generate system demand signals to influence a vehicle's motion via the anti-roll actuators 272, 282. An actuator provided between a front pair of wheels of a vehicle may be called a front actuator. A front active roll control (FARC) module may be electrically connected to the front actuator, and may comprise the controller 250 to control the front actuator 272. Similarly, an actuator provided between a rear pair of wheels of a vehicle may be called a rear actuator. A rear active roll control (RARC) module may be electrically connected to the rear actuator and may comprise a controller 260 to control the rear actuator 282.

The front and rear anti-roll actuators 272, 282 comprises an electric motor which is controllable by the respective anti-roll controller 250, 260. Each of the front and rear anti-roll actuators 272, 282 may be controlled by its own respective anti-roll controller in some examples, or multiple anti-roll actuators may be controlled by a common anti-roll controller in some examples. Each of the anti-roll actuators 272, 282 may be individually controlled in some cases to improve the management of the roll of the body of the vehicle. The front and rear anti-roll actuators 272, 282 may be controlled by a control signal which is generated by the controller 240 may generate and output, through the output channel 245, to the anti-roll bar controllers 250, 260. The control signal may carry instructions to be implemented by the actuator, for example by providing a torque to apply to the anti-roll bar. For example, as discussed above, when the vehicle is cornering, a control signal may be transmitted to the anti-roll bar controllers 250, 260, which may in turn transmit a control signal via interface 255, 265, so that the front and read anti-roll actuators 272, 282 may mitigate a body roll effect. Similarly, anti-roll bar controllers 250, 260 may transmit measured values from the anti-roll actuators to the controller 240 through output channel 245.

FIG. 2b shows an example control system 200 for a vehicle comprising one or more modules 210, 220, 230, a controller 240 and front and rear anti-roll bars 272, 282. As in FIG. 2a, the control system 200 comprises a controller 240 which is connected by a communication channel 245 to controllers 250, 260 configured to respectively control front and rear anti-roll bar actuators 272, 282. Further, the controller 240 of the control system 200 is in a communicative connection to the one or more modules 210, 220, 230 via a communications bus 205. The one or more modules 210, 220, 230 may be configured to perform functions relating to power supply of the suspension system. Module 210 may be a power control module configured to control a power supply system for the suspension system. Module 220 may be a conversion module configured to convert electrical energy output from the power supply system. In an example, the conversion module 220 may comprise a DC-DC converter. Module 230 may be a capacitor or supercapacitor module configured to store electrical energy for the suspension system. Together, conversion module 220 and capacitor module 230 may be configured to supply electrical energy to the controllers 250, 260, such that the anti-roll bar actuators 272, 282 can be actuated. FIG. 2b illustrates these modules 210, 220, 230 as individual modules. However, there may be examples whereby components within the modules 210, 220, and 230 are included in a single module.

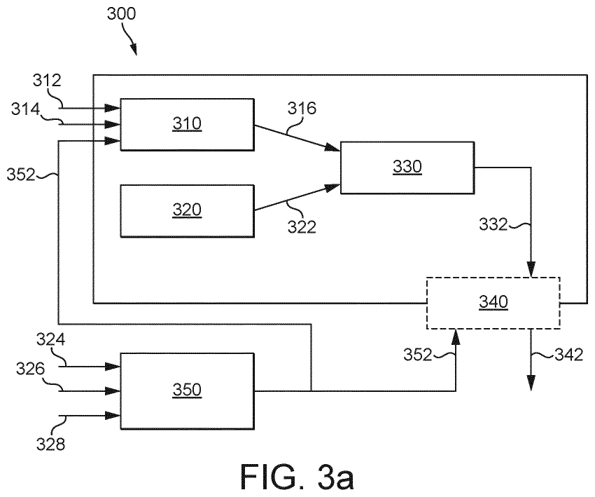

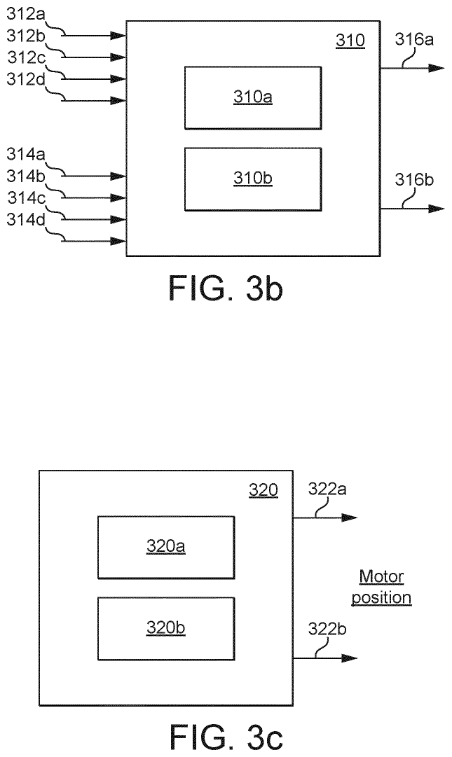

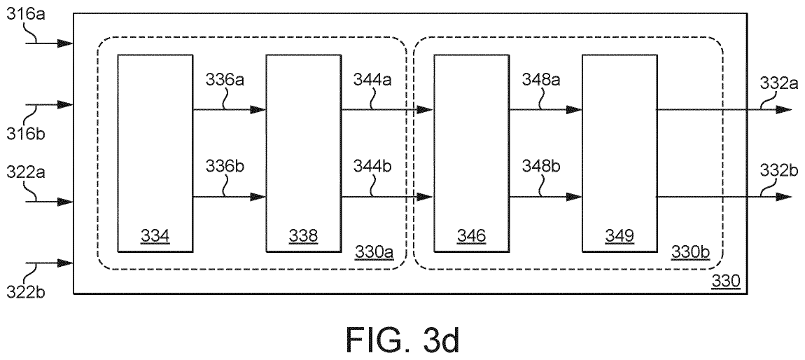

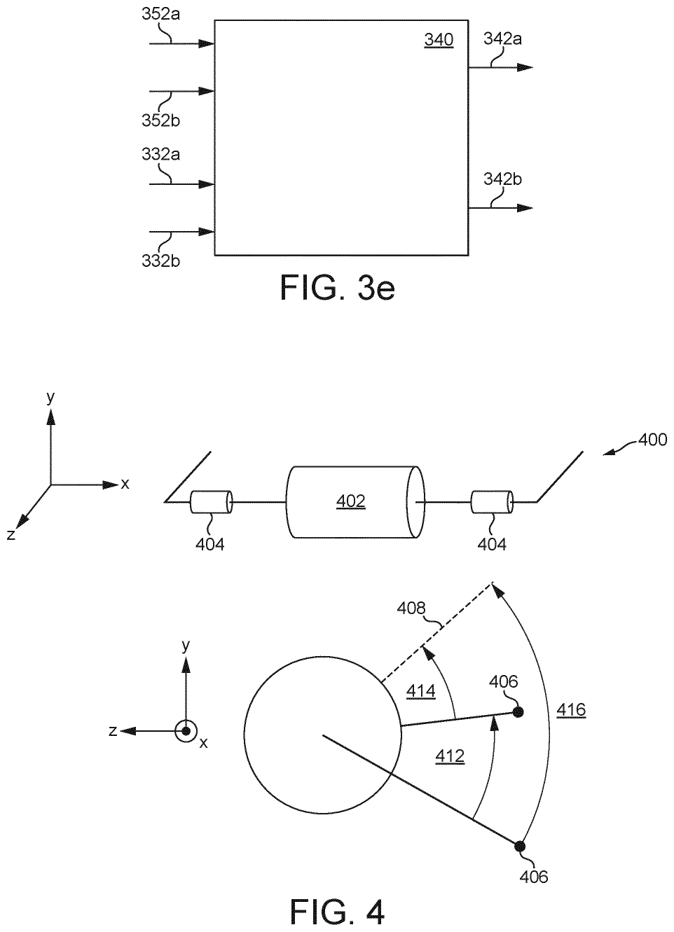

FIG. 3a shows an example module 300 for a control system of a vehicle. The module 300 may, for example, form a part of a controller 240 such as shown in FIGS. 2a-b. The module 300 may be, or may be a part of, a control system 100, 200 as described above. The module 300 may be called a control module 300. The control module 300 comprises a series of modules 310, 320, 330, 340 which are described in more detail with respect to FIGS. 3b-3d below. The following discussion is set out in terms of a module 300, but it will be understood that this discussion also applies to a control system 100, 200 or controller 240 comprising such a control module 300.

The control module 300 is configured to provide processing which mitigates between a lower level of functionality of the individual systems 250, 260 of the system 200 of FIGS. 2a-2b, and the higher level of functionality of the overall actuator system 200. The control module 300, in particular the torque estimation module 330, is able to provide a roll bar torque estimation which is based on determined mechanical movement (from the anti-roll control module 320) and based on modelling of the vehicle and suspension systems (from the kinematic model module 310. By making use of both physics based (analytical modelling and signal processing) and empirical modelling, advantages effects of both approaches may provide an improved torque estimation. In some examples, a current torque demand may be input to the kinematic model module 310 and may help enhance the accuracy of the disturbance angle 316 calculation.

The control module 300 comprises a module 310 described in relation to FIG. 3b which provides kinematic model functionality. That is, the estimation process at module 330 comprises using models to obtain the disturbance angles in module 310 which feeds into the estimation module 330. Suspension displacement signals 312, hub acceleration signals 314, and a current torque demand 352 may be mapped to the roll bar movements, for example via a kinematics model and using a Kalman filter. The resulting roll bar derived signals may be referred to as disturbance angle 316. In other words, the kinematic model module 310 can take, as input, suspension displacement signals 312, hub acceleration signals 314, and a current torque demand 352, and provide, as output, a disturbance angle 316. The output 316 may be provided to the further estimation module 330.

The control module 300 comprises a module 320 described in relation to FIG. 3c which provides anti-roll control functionality. Motor displacement signals 322, measured via dedicated sensors, may also be obtained. This anti-roll control module 320 can thus provide, as output, motor displacement signals 322. The output 322 may be provided to the further estimation module 330.

The control module 300 comprises a module 330 described in relation to FIG. 3d which provides torque estimation functionality and may thus be called a torque estimation module 330. The torque estimation module 330 is configured to receive a disturbance angle 316 of an actuator of the vehicle suspension system. The disturbance angle 316 is indicative of a determined relative angular displacement between ends of the roll bar caused by the vehicle interacting with a driving surface. The torque estimation module 330 is also configured to receive a displacement value 322 of an actuator motor of the actuator of the vehicle suspension system. The displacement value 322 of the actuator motor is indicative of a sensed displacement of the actuator motor caused by the vehicle interacting with the driving surface. The torque estimation module 330 is configured to determine, in dependence on the disturbance angle 316 of the roll bar and the displacement value 322 of the actuator motor, a torque estimation 332. The torque estimation 332 represents an expected torque provided by the actuator motor to a roll bar connected to the actuator motor. The torque estimation module 330 is configured to output the torque estimation 332 to a further vehicle system 340. In this example the torque estimation 332 is shown as being output to a torque diagnostic module 340 described below.

The torque estimation process in the module 330 may comprise identification of an appropriate model, such as a linear time-invariant (LTI) model, to describe a transfer function between disturbance angle 316 and/or the motor displacement 322 signals, and a measured roll bar torque. Filters may be employed, for example filters calibrated using steady state rejection filters, for input signals representing the disturbance angle and/or motor positions to reduce steady state offsets from the signals (for example in a scenario such as vehicle kerb starts in which there is an initial steady offset due to being parked on an angle on the kerb). Such filters may be used to remove the steady state offsets, since input offsets may translate into artificial output torque offsets which are not representative of the system outside the “offset” conditions. Further filtering may be used in some examples to reduce high frequency noise in estimated torque signals through filtering, for example, the actuator raw estimated torque. The offset rejection filter cut off frequencies may be different from the front and rear axles.

A further module 350, which may be called a torque demand calculation module 350, is also illustrated in connection with the control module 300. The torque demand calculation module 350 provides, as output, the current torque demand 352. The current torque demand output 352 is provided here to the torque diagnostic module 340. The torque demand calculation module 350 may receive as input, for example, vehicle level information such as vehicle sensor information, and possibly status signals from one or more further modules, over one or more communication buses 324, 326, 328 (or if the sensor is hard-wired, via that wired connection), and determine the current torque demand 352 from this input.

The control module 300 comprises a module 340 described in relation to FIG. 3e which provides torque diagnostic functionality, and thus may be called a torque diagnostic module 340. In some examples, rather than being part of the control module 300, module 340 is separate from and in communication with the control module 300. The torque diagnostic module 340 may be configured to determine a function of the difference between the torque estimation 332 and a current torque demand 352 being requested by the vehicle suspension system. The function of the difference may be the difference, with one or more processing steps applied to the estimated torque. The function of the difference may be a function of the processed estimated torque and the demanded torque in some examples. In this example the current torque demand 352 is provided by the torque demand calculation module 350. The torque demand 352 is the torque requested by the vehicle suspension system in response to the vehicle interacting with the driving surface, and in some examples the driver inputs. If the determined function of the difference is above a predetermined threshold, the torque diagnostic module 340 is configured to output a fault signal 342. For example, the fault signal 342 may be output to a dedicated torque fault bus so that a fault alert may be provided to a user.

FIGS. 3b-3e show example modules of the control system 300 of FIG. 3a. FIG. 3b shows an example kinematic model module 310. This module 310 uses suspension height and hub accelerometer sensors, and torque demand signals 352 as inputs to a Kinematic Model 310a and a Kalman Filter 310b to estimate the road disturbance angle (front and rear).

The kinematic model module 310 comprises a kinematics module 310a, and a Kalman filter module 310b. One or more vehicle level sensor signals, suspension displacement and acceleration signals, and system torque demands, may be mapped to the roll bar movements, using a kinematics model by the kinematics module 310a. For example, vehicle sensor signals which are indicative of the vehicle interacting with a driving surface and which may be received as input to the kinematic model module 310 include a height of a left side and a height of a right side of the vehicle suspension, as determined by respective suspension height sensors (for example a front left side sensor 312a and a rear left side sensor 312b, and a front right side sensor 312c and a rear right side sensor 312d). Such information may be called vehicle suspension information or vehicle suspension displacement information. Other example vehicle sensor signals comprise a position of the actuator motor determined by an actuator motor position sensor. Such information may be called suspension actuator movement information. Other example vehicle sensor signals comprise an acceleration of one or more hubs of a wheel of the vehicle determined by a respective hub acceleration sensor (for example a front left side sensor 314a and a rear left side sensor 314b, and a front right side sensor 314c and a rear right side sensor 314d). Other example vehicle sensor signals comprise the current torque demand requested by the vehicle suspension system determined by the vehicle level controller 350. The current torque demand represents the target torque that the system must achieve to deliver vehicle level attributes. (and may be determined by the vehicle level controller 350 based on obtained sensor information, such as from a front axle torque demand sensor and a rear axle torque demand sensor). Such signals 312a-d may be input into the a theoretical model at kinematic module 310a. The theoretical model may comprise a kinematic model 310a which is configured to estimate behaviour of the vehicle suspension system in dependence on a geometry of the vehicle suspension system and a torque demand applied to the vehicle suspension system. The kinematic model module 310 may determine the disturbance angle of the roll bar in dependence on the at least one sensor signal 312a-d and an estimated behaviour determined from the theoretical model 310a.

The kinematic model module 310 may also comprise a Kalman filter module 310b which is configured to use the vehicle dynamic model 310a (for example, physical laws of motion) and multiple sequential measurements system (for example the sensor inputs 312a-d and 314a-d) to form an estimate of the vehicle suspension systems varying quantities that is better than an estimate obtained by using only one measurement alone. The resulting roll bar derived signals (for example a front actuator signal 316a and a rear actuator signal 316b) may be referred to as disturbance angles or roll bar disturbance angles.

FIG. 3c shows an anti-roll control module 320. In this example the module 320 comprises a front anti-roll control module 320a and a rear anti-roll control module 320b. The anti-roll control module 320 may use one or more sensing elements 320a-b to obtain the motor displacement measurements 322a-b from each axle.

FIG. 3d shows an example torque estimation module 330. This module 330 provides the method of estimating the roll bar torque (for example for the front and rear axle actuators, independently. Broadly, it is configured to identify a model (for example a linear time invariant model) to well-describes a transfer function between disturbance angle/motor position (from modules 310 and 320 respectively) and roll bar torque. It is configured to a calibrating steady state rejection filters for input signals (for example scenarios such as vehicle kerb starts and other scenarios which provide temporary input offsets which translate into artificial output torque offsets. It is also configured to calibrate frequency content of outputs (i.e. estimated torque), for example by a low pass filter 349 applied to the estimation raw output to remove high frequency components. The cut off frequency of the low pass filter, and the steady state rejection filters, may be calibratable.

The torque estimation module 330 may be considered to comprise a first calculation component which is an analytical portion 330a, and a second calculation component which is an empirical portion 330b. The analytical portion 330a provides the first calculation component based on a predetermined model of the vehicle suspension system, for example taking into account the geometry and physics of the actuators and suspension system. For example, the first calculation component may be based on an analytical model of the vehicle suspension system. The empirical portion 330b provides the second calculation component based on at least one vehicle characteristic for example taking into account the compliances of the actuators (for example the system level compliances, the vehicle level compliances), as determined in earlier testing of those components. For example, the second calculation component may be based on an empirical model of a plurality of vehicle characteristics.

The inputs into the torque estimation module 330 in this example are the front and rear actuator signals 316a-b from the kinematic model module 310, and the motor displacement measurements 322a-b from the anti-roll control module 320. In an example, the disturbance angle signals 316a-b are determined in dependence on the at least one sensor signal and an estimated behaviour determined from the theoretical model, and the actuator motor positions 322a-b are determined by actuator motor position sensors. In such examples, the first calculation component 330a, or analytical portion 330a, is configured to performing one or more corrections in a signal conditions and offset rejection module 334. Example corrections include correcting an offset of the determined disturbance angle (i.e. removing the DC component, or 0 Hz component, from the signal); and correcting an offset of the sensed position of the actuator motor. If the disturbance angle and actuator motor positions are corrected, the first calculation component 330 may comprise a function dependent on one or more of the offset corrected disturbance angle, the offset corrected actuator motor position, and a roll bar stiffness characteristic 338. The stiffness characteristic may be different for the front and rear axles. The stiffness characteristic 338 does not itself perform any offset correction. The offset corrected disturbance angle and offset corrected motor position 336a-b (taken as a pair per axle) may be fed into the displacement/stiffness characteristic 338 which then generates the axle actuator raw estimated torque 344a-b (for example the front disturbance angle and front motor position are used to generate the front axle actuator raw estimated torque signal). This is then fed into the second calculation step 330b.

In some examples, the control system 300 (for example the torque estimation module 330) may be configured to determine if the at least one sensor signal used in the first calculation component 330a produces an artificial torque offset in the vehicle suspension system. In dependence on determining that the at least one signal produces the artificial torque offset, the artificial torque offset may be rejected. For example, if the vehicle is parked on a kerb and the drive cycle begins, a steady state offset arises from the vehicle being parked on non-flat ground. This steady-state offset may be identified and compensated for (i.e. the offset due to being parked on the kerb is removed from the signals).

The second calculation component 330b, or empirical portion 330b, in this example, is configured to receiving a result (i.e. front and rear axle actuator raw estimated torques 344a-b) from the first calculation component 330a and perform empirical modelling to account for physical parameters of the vehicle. Different empirical model may be used for the front and the rear axles. The empirical portion 330b may be configured to compensate for at least one vehicle characteristic in dependence on the result from the first calculation component 344a-b, and a system identification model, in dynamics estimation module 346. The at least one vehicle characteristic may be indicative of a change in geometry of the vehicle suspension system in response to a torque demand. The at least one vehicle characteristic may be indicative of dynamic interactions between the roll bar and the vehicle, in response to the vehicle suspension system interacting with the driving surface and in response to a torque demand.

The system identification model used in the dynamics estimation module 346 may be determined in dependence on measured data relating to at least one of: a compliance parameter of one or more components of the vehicle; a user induced movement; data from the one or more sensors (for example a motor position, suspension displacement, and wheel hub acceleration); and an associated measured torque (for example from a dedicated torque sensor or other sensing method). The measured data may be obtained from a plurality of different vehicle drive cycles. The system identification model uses statistical methods to build mathematical models of dynamical systems from measured data. For example, a linear time invariant transfer function (pole/zero configuration) may be derived from the input and output data using an Instrumental Variable method, to provide good accuracy in estimating the torque. Other example system identification methods and model structures (such as state space, nonlinear transfer functions) may be used as well.

The front and rear axle actuator raw estimated torque values, as compensated for vehicle compliance 348a-b, which are provided from the dynamics estimation module 346, may then be filtered in a high-frequency filtering module 349 to reject high frequency noise. The resulting outputs 332a-b are front and rear axle actuator estimated torques 332a-b.

FIG. 3e shows a torque diagnostic module 340. This module is configured to take, as input, the front and rear axle actuator estimated torques 332a-b from the torque estimation module 330, and the current front and rear axle actuator torque demands 352a-b from the torque demand calculation module 350. The torque demand calculation module 340 is configured to provide, as output, front and/or rear axle actuator 342a-b fault signals, for example to a dedicated torque fault bus, so that a fault alert may be provided to a user. Thus, the torque demand calculation module 340 acts as a comparator, whereby if the estimated torque being provided by the suspension system 332a-b is different from the actual current front and rear axle actuator torque demands 352a-b by more than a predetermined tolerance, this may be interpreted as a possible fault and an alert may be provided. In other words, if the function of the difference between the torque being provided by the suspension system 332a-b and the torque demand 352a-b is more than pre-determined tolerance for a predetermined time period, this may be interpreted as a possible fault and an alert may be provided.

FIG. 4 illustrates an actuator geometry indicating disturbance angle. The displacement angle may be defined as the angular difference calculated at the roll bar ends, for example at the roll bar spade ends. The motor may displace by a different angular amount independent of the spade ends. The active suspension anti-roll bar 400 in this example comprises an actuator 402 and bushes 404 to either side. During cornering, a torque is applied to prevent roll and the suspension deflects as a result. This deflection influences the relationship between the height sensor and the actuator disturbance angle. A torque may be created along the longitudinal axis of the anti-roll bar centre line (i.e. through the bushes 404 and actuator 402 along the x axis) in order to apply a force to the drop links 406 of the suspension. The torque demand and feedback may be expressed as an angle 414 of torsion existing in the assembly multiplied by its stiffness (K, Nm/rad). The angle of torsion 414 is illustrated as the difference between the angular separation 412 of the drop link points 406, and the total actuator rotation 416 (indicated by the lower drop link 406 and the dashed line 408. With 0 Nm of torque in the assembly the angle 414=0 rad. The system torque is linearly proportional to the value of angle 414 and the stiffness K. The relative angular position between the bar ends is defined as the disturbance angle 412.

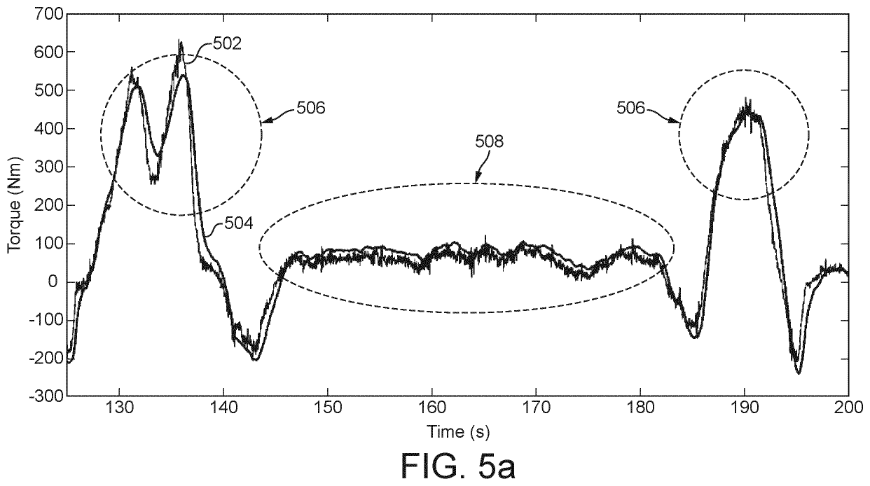

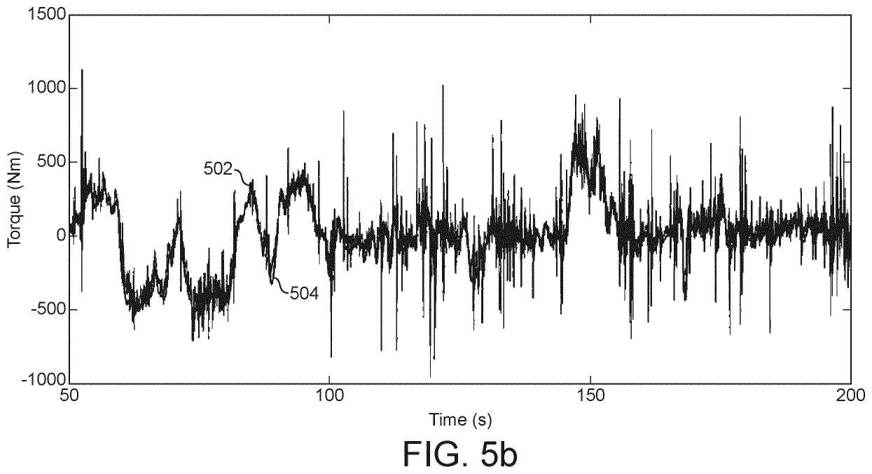

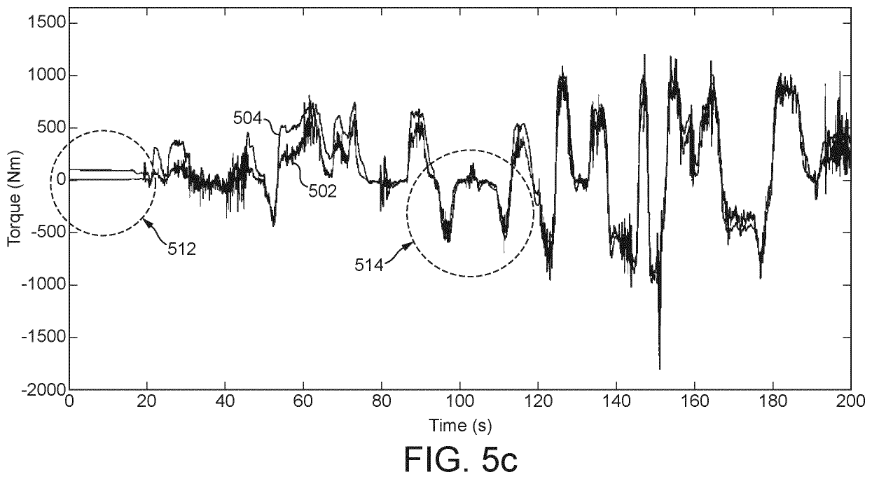

FIGS. 5a-c show data indicating measured and estimated torque for a vehicle performing under different driving conditions, with estimation of torque performed as described above. FIG. 5a illustrates example measured 502 and estimated 504 torques of a vehicle against time, with the vehicle performing motorway driving. It can be seen in regions 506 of both high and low torque amplitude events that there is a good correlation between the measured 502 and estimated 504 torques. At low torque levels 508, the estimation method well encompasses noise rejection.

FIG. 5b illustrates example measured 502 and estimated 504 torques of a vehicle against time, with the vehicle driving over rough road terrain (for example a dirt road or gravelled track). It can be seen that there is a good correlation between the measured 502 and estimated 504 torques. Road induced noise is rejected across all the measured torque amplitude levels.

FIG. 5c illustrates example measured 502 and estimated 504 torques of a vehicle against time, with the vehicle driving in a way to induce steady state errors in the estimated torque. For example, just after time t=0 s, it can be seen in region 512 that the estimated torque is offset from the actual torque by a constant value, which has arisen because the vehicle started the drive from a kerb-parked start in which one side of the vehicle is parked on higher-level ground that the opposite side. However, after around 100 s of driving in region 514 the estimation of torque has effectively rejected the steady state offset error and the measured 502 and estimated 504 torques have a good correlation. In other words, good steady state error correction is achieved after around 100 s of driving in this example.

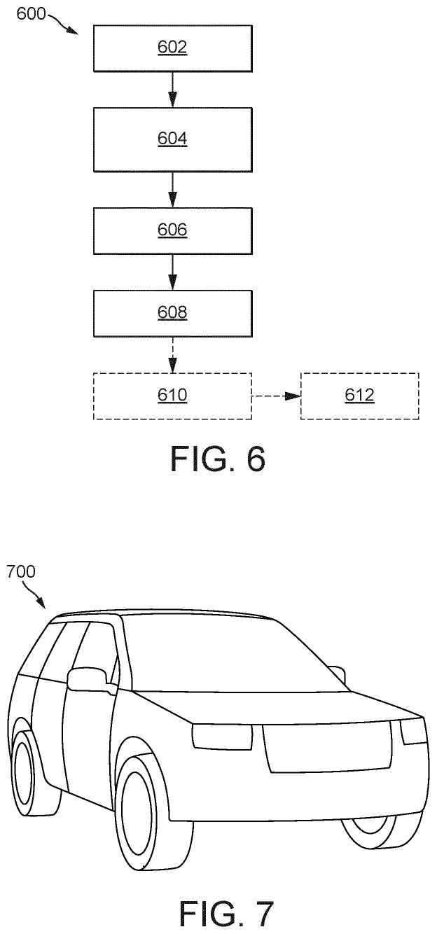

FIG. 6 shows an example method 600 which may be performed by control systems as disclosed herein. The method 600 comprises: receiving a disturbance angle 602 of an actuator of a vehicle suspension system in a vehicle. The disturbance angle is indicative of a determined relative angular displacement between ends of the roll bar caused by the vehicle interacting with a driving surface. The method 600 comprises receiving a displacement value of an actuator motor 604 of the actuator of the vehicle suspension system. The displacement value of the actuator motor is indicative of a sensed displacement of the actuator motor caused by the vehicle interacting with the driving surface and in some examples the driver inputs. The “sensed” displacement may be an estimated displacement in some examples. The method 600 comprises calculating 606, using the disturbance angle of the roll bar and the displacement value of the actuator motor, a torque estimation. The torque estimation represents an expected torque being provided by the actuator motor to a roll bar connected to the actuator motor. The method 600 comprises outputting 608 the torque estimation.

The method 600 in some examples may comprise determining a function of a difference 610 between the torque estimation and a current torque demand being requested by the vehicle suspension system, the torque demand being requested by the vehicle suspension system in response to the vehicle interacting with the driving surface; and if the determined difference is above a predetermined threshold, outputting a fault signal 612 to a fault bus of the vehicle suspension system. The method 600 in some examples may comprise calculating the torque estimation using a first calculation component and a second calculation component, wherein the first calculation component is based on a theoretical model of the vehicle suspension system and the second calculation component is based on at least one vehicle characteristic.

The blocks illustrated in FIG. 6 may represent steps in a method 600 and/or sections of code in a computer program configured to control the control system as described above to perform the method steps. The illustration of a particular order to the blocks does not necessarily imply that there is a required or preferred order for the blocks and the order and arrangement of the block may be varied. Furthermore, it may be possible for some steps to be omitted or added in other examples. Therefore, this disclosure also includes computer software that, when executed, is configured to perform any method disclosed herein, such as that illustrated in FIG. 6. Optionally the computer software is stored on a computer readable medium, and may be tangibly stored.

FIG. 7 shows a vehicle 700 comprising a control system 100 as described above, or a system 100 as described above. The vehicle 700 in the present embodiment is an automobile, such as a wheeled vehicle, but it will be understood that the control system and active suspension system may be used in other types of vehicle.

As used here, ‘connected’ means ‘electrically interconnected’ either directly or indirectly. Electrical interconnection does not have to be galvanic. Where the control system is concerned, connected means operably coupled to the extent that messages are transmitted and received via the appropriate communication means.

It will be appreciated that various changes and modifications can be made to the present invention without departing from the scope of the present application. Whilst endeavouring in the foregoing specification to draw attention to those features believed to be of particular importance it should be understood that the Applicant claims protection in respect of any patentable feature or combination of features hereinbefore referred to and/or shown in the drawings whether or not particular emphasis has been placed thereon.

1-15. (canceled)

16. A control system for a vehicle suspension system in a vehicle, the control system comprising one or more controllers, the control system configured to:
receive a disturbance angle of a roll bar of the vehicle suspension system, the disturbance angle indicative of a determined relative angular displacement between ends of the roll bar caused by the vehicle interacting with a driving surface;
receive a displacement value of an actuator motor of the actuator of the vehicle suspension system, the displacement value of the actuator motor indicative of a sensed displacement of the actuator motor caused by the vehicle interacting with the driving surface;
determine, in dependence on the disturbance angle of the roll bar and the displacement value of the actuator motor, a torque estimation, the torque estimation representing an expected torque provided by the actuator motor to the roll bar connected to the actuator motor; and
output the torque estimation to a further vehicle system.

17. The control system of claim 16, wherein the control system is configured to:
determine a function of the difference between the torque estimation and a current torque demand being requested by the vehicle suspension system, the torque demand being requested by the vehicle suspension system in response to the vehicle interacting with the driving surface; and
if the determined function of the difference is above a predetermined threshold, output a fault signal.

18. The control system of claim 16, wherein the control system is configured to:
calculate the torque estimation using a first calculation component and a second calculation component, wherein the first calculation component is based on a predetermined model of the vehicle suspension system and the second calculation component is based on at least one vehicle characteristic.

19. The control system of claim 18, wherein determining the first calculation component comprises:
receiving at least one sensor signal indicative of the vehicle interacting with a driving surface;
inputting the at least one sensor signal into the theoretical model, wherein the theoretical model comprises a kinematic model configured to estimate behavior r of the vehicle suspension system in dependence on a geometry of the vehicle suspension system and a torque demand applied to the vehicle suspension system; and
determining the disturbance angle in dependence on the at least one sensor signal and an estimated behavior determined from the theoretical model.

20. The control system of claim 19, wherein the at least one sensor signal indicates:
one or more of a height of a left side and a height of a right side of the vehicle suspension determined by a respective suspension height sensor;
a position of the actuator motor determined by an actuator motor position sensor;
an acceleration of one or more hub of a wheel of the vehicle determined by a respective hub acceleration sensor; and
the current torque demand requested by the vehicle suspension system determined by a vehicle level controller.

21. The control system of claim 20, wherein, when:
the disturbance angle is determined in dependence on the at least one sensor signal and an estimated behavior determined from the theoretical model, and
the actuator motor position is determined by the actuator motor position sensor, the first calculation component comprises one or more of:
correcting an offset of the determined disturbance angle;
correcting an offset of the sensed position of the actuator motor; and
a function dependent on one or more of the offset corrected disturbance angle, the offset corrected actuator motor position, and a roll bar stiffness characteristic.

22. The control system of claim 18, wherein the second calculation component comprises:
receiving a result from the first calculation component; and
compensating for the at least one vehicle characteristic in dependence on the result from the first calculation component and a system identification model, wherein the at least one vehicle characteristic is indicative of a change in geometry of the vehicle suspension system in response to a torque demand.

23. The control system of claim 22, wherein the system identification model is determined in dependence on measured data relating to at least one of:
a compliance parameter of one or more components of the vehicle;
a user induced movement;
data from the one or more sensors; and
an associated measured torqued;
wherein the measured data is obtained from a plurality of different vehicle drive cycles.

24. The control system of claim 19, wherein the control system is configured to:
determine if the at least one sensor signal used in the first calculation component produces an artificial torque offset in the vehicle suspension system; and
in dependence on determining that the at least one signal produces the artificial torque offset, rejecting the artificial torque offset.

25. A system, comprising:
the control system according to claim 1;
at least one sensor configured to measure data relating to a vehicle travelling on a driving surface; and
an actuator of a vehicle suspension system in a vehicle, the actuator comprising at least one actuator motor functionally connected to at least one roll bar, the actuator motor configured to apply a torsional force on the at least one roll bar.

26. A vehicle comprising the control system according to claim 16.

27. A method, comprising:
receiving a disturbance angle of a roll bar of a vehicle suspension system in a vehicle, the disturbance angle indicative of a determined relative angular displacement between ends of the roll bar caused by the vehicle interacting with a driving surface;
receiving a displacement value of an actuator motor of the actuator of the vehicle suspension system, the displacement value of the actuator motor indicative of a sensed displacement of the actuator motor caused by the vehicle interacting with the driving surface;
calculating, using the disturbance angle of the roll bar and the displacement value of the actuator motor, a torque estimation, the torque estimation representing an expected torque provided by the actuator motor to a roll bar connected to the actuator motor; and
outputting the torque estimation.

28. The method of claim 27, comprising:
determining a function of a difference between the torque estimation and a current torque demand being requested by the vehicle suspension system, the torque demand being requested by the vehicle suspension system in response to the vehicle interacting with the driving surface; and
if the determined difference is above a predetermined threshold, outputting a fault signal to a fault bus of the vehicle suspension system.

29. The method of claim 27, comprising:
calculating the torque estimation using a first calculation component and a second calculation component, wherein the first calculation component is based on a theoretical model of the vehicle suspension system and the second calculation component is based on at least one vehicle characteristic.

30. Computer readable instructions arranged to perform a method according to claim 27.
